(19) United States
(12) Patent Application Publication
(10) Pub. No.: US 2009/0100725 A1
(43) Pub. Date: Apr. 23, 2009

(54) Cover for Temporary License Plate and System for Printing Temporary License Plates

(76) Inventor: Christopher D. Freeman, Sunrise, FL (US)

Correspondence Address: Fleit Gibbons Gutman Bongini & Bianco P.L., 21355 E. Dixie Highway, Suite #115, Miami, FL, 33180, US

(21) Appl. No.: 12/127,169

(22) Filed: May 27, 2008

Related U.S. Application Data
(60) Provisional application No. 60/940,189, filed on May 25, 2007.

(51) Int. Cl. G09F 7/00

(52) U.S. Cl. 40/209

(57) ABSTRACT

A cover for temporary license plate provides a temporary license plate that is durable, that cannot be doctored or counterfeited, and that must be registered with the state.

### CROSS-REFERENCE TO RELATED APPLICATIONS

This application claims the benefit of U.S. Provisional Application No. 60/940,189, filed May 25, 2007.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to covers for temporary license plates, vehicle registrations, and anti-counterfeiting measures for temporary vehicle tags.

2. Description of the Related Art

Temporary license plates are short lasting license plates that are used to identify an automobile and to register the car and its owner with the issuing state government.

Temporary license plates are made of paper. Paper is used because it is inexpensive. Because temporary license plates are intended to last only short times, until a permanent, metal plate arrives, the lack of durability and waterproofing of paper tags is outweighed by the saving. Temporary license plates are easily effected by weather conditions or high winds caused by moving vehicles. Vehicle owners add frames, covers, or place temporary license plates in the rear windows of vehicles to protect them.

Florida is typical of most states. The state prints a series of temporary tags. Each tag has a unique number and some blank fields for writing the Vehicle Identification Number (VIN) and the expiration date of the tag. Car dealers, brokers, and tag agencies (i.e. tag issuers) buy a sequence of temporary tags for resale. The state tracks which plates are sold to which tag issuer. When purchased, the tag issuer writes in the expiration date and the VIN. The user then places the completed temporary tag on their car until the permanent tag arrives, at which time, the temporary tag is replaced.

A news story by WESH titled, “Temporary Tags Are Criminals Best Friends,” describes two problems with temporary tags. First, law enforcement is unable to correlate a temporary tag number with an owner of a car. Second, temporary tags are too easy to counterfeit and adulterate (i.e. add or change information).

Law enforcement officers request information about drivers and vehicles by connecting to online databases. When the license plate is a permanent tag, the officer can determine what type of vehicle is associated with the tag, who owner of the vehicle, and what information (i.e. warrants and criminal history) is relevant about the driver. Law enforcement agents can then make quick decisions to protect themselves and to detain suspicious vehicles and drivers.

When a law enforcement officer contacts the state about a temporary tag, the returning information is about the tag issuer, not the vehicle or vehicle owner. The law officer must then contact the tag issuer, if available, to correlate the temporary tag number to the information regarding VIN and car owner that is being kept by the tag issuer. In the intervening time, a suspect may be allowed to leave or may threaten the law officer.

Because temporary licenses plates are made of paper, they are easily counterfeited. In a large number of states (e.g. Florida) temporary license plates are completed by hand. Handwritten notations are easily altered. The alterations can be as minor as changing the expiration date to changing the VIN number to hide a stolen car. Fraudulent alterations make temporary license plates a tool for criminals, organized crime, and even potential terrorists.

Temporary tags can lead to lost revenue for the state. Most temporary license plates can enable dishonest vehicle owners to avoid registration fees because they can change the expiration date to extend it and thereby avoid buying another temporary tag or permanent plate. Violations that are charged to doctored temporary license plates, like toll violations, parking citations, and traffic infractions caught by police surveillance can all go unpaid because they cannot be charged back to the owner of the vehicle.

The paper material of plates contributes to theft and counterfeiting. Paper temporary tags are frail enough to be torn from vehicles by thieves. Paper tags with monochromatic black printing on them can then be photocopied or digitally manipulated to create counterfeit prints. Because a tag is observed from a distance, often at high speeds, counterfeits become even harder to detect.

### BRIEF SUMMARY OF THE INVENTION

It is accordingly an object of the invention to provide a cover for temporary license plate that which overcomes the above-mentioned disadvantages of the heretofore-known devices, methods, and systems of this general type.

An object of the invention is to provide a temporary license plate that is durable, that cannot be doctored or counterfeited, and that must be registered with the state.

The temporary license plate is a printable sheet (i.e. a paper backing) with a transparent layer that is peelably adhered to the printable sheet with pressure-activated adhesive.

The printable sheet is precut (i.e. scored) into sections. The first section is a rectangular license plate section. Beside each side of the license plate section is a guide rail. A top edge of the license plate section forms the top edge of the printable sheet. A center section that is at least as large as the license plate section (and preferably equal height as the license plate section) is formed below the license plate section on the printable sheet. A bottom margin is included on the printed sheet that forms the bottom edge of the temporary tag.

The temporary license plate may have the tag number preprinted by the state. Alternatively, the temporary tag can be a blank that is printed upon demand.

The license plate section is peeled from the transparent backing. The license plate section is placed into a printer of the tag issuer. If necessary, the tag number is printed on the license plate section as well as the expiration date and the VIN.

Accordingly, the invention provides a temporary license plate that can be electronically printed on-demand and has its own self laminating security cover.

The tag can be preprinted with a tag number or printed on demand by the tag issuer.

If the temporary license plate is preprinted, the state preprints a unique tag number on the temporary license plate. The VIN and expiration date, and possibly additional information are printed by the tag issuer.

If the temporary license plate is blank, the tag issuer prints the tag number, the VIN, and the expiration date.

Regardless of whether the temporary license plate is preprinted, at least some of the information must be printed onto the temporary tag. The printer of the tag issuer is connected to a computer, which is in turn connected via a network such as the Internet to a database at the Department of Motor Vehicles (DMV). The database associates a temporary tag number, with a VIN, vehicle owner, and expiration date. The database can be connected to other databases such as the state's criminal records or court's listing of outstanding warrants. By propagating the database, the information on the tag, the vehicle, and the possibly other information can be made available to law enforcement officers. The printer can be customized to print the tags. The printer can use specific inks to discourage counterfeiting. Likewise, a specific, uncommon or proprietary font can be used to print the information. By using a unique font, genuine tags can be distinguished from counterfeits.

Once the temporary tag is printed, it is returned to the backing from where it was removed. The pressure activated adhesive is used to permanently fix the printed tag to the transparent backing.

In the next step, the guide rails are removed and the center section is removed. The transparent backing is then folded to cover and adhere to the face of the printed tag.

Lastly, the bottom margin is removed and the now exposed section of the transparent backing is folder over rear of the printed temporary tag. Accordingly, the temporary tag is sealed in the transparent backing.

The center portion can include information to be printed. In particular, a vehicle registration card can be printed that matches the information printed on the temporary tag. In a vehicle stop, the vehicle registration can be matched with the temporary tag. A counterfeiter with only the tag but not the registration will not be able to produce the registration.

The center portion can include an insurance affidavit. An insurance affidavit is a statement from the registrant of a vehicle that the owner has the required insurance. The statement is required by some state's law and completing the affidavit shield the tag issuer from liability, even if the owner was actually un- or underinsured.

The temporary license plate according to the invention is printed on demand by the tag issuer. By printing temporary license plates on-demand, filling in preprinted temporary license plates by hand will be a thing of the past. After printing the temporary license plates, the issuing agent can seal it with the provided self laminating security cover. The security cover deters fraud, theft, and provides protection against weather conditions. The security cover according to the invention make the temporary license plate durable enough to be properly displayed on the rear of the vehicle with frames or additional covers. Once the cover is sealed the cover cannot be reopened without destroying the temporary license plate. The self laminating license plate covers utilize a pressure-sensitive adhesive and do not require any additional equipment to laminate. With a few simple folds, the temporary license plate is covered.

By having a one piece product, security features can be added and sealed in with the license plate as needed. Our license plates are easily printed by a computer. Because the temporary tag cover is a one piece product it will give any State's license plates a uniform look and feel. The uniform look and feel will make it easer for law enforcement to detect fraud.

Our product provides a low cost and effective way to increase public safety and state revenues. All In One license plates have addressed all of the current temporary license plate security concerns. The overall quality and durability has been taken a step further. All In One license plates address further issues like printing license plates on-demand. Thus All in One license plate and covers are one piece products that leave room for further security concerns.

Although the invention is illustrated and described herein as embodied in a cover for temporary license plates, it is nevertheless not intended to be limited to the details shown, because various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a front side view of the Cover.

FIG. 2 is a rear side view thereof.

FIG. 3 is a front side view after the paper backing has been removed and the adhesive layer has been folded over itself.

FIG. 4 is a rear side view of the folded adhesive layer shown in FIG. 3.

FIG. 5 is a bottom side view of the folded adhesive layer shown in FIG. 3.

FIG. 6 is a top side view of the folded adhesive layer shown in FIG. 3.

FIG. 7 is a left side view of the folded adhesive layer shown in FIG. 7; the right side view is a mirror image of the left side view.

FIG. 8 is a front side view of a temporary license plate.

FIG. 9 is a perspective view showing the cover in relation to the temporary license plate.

FIG. 10 is a front side view of the cover.

FIG. 11 is a front side view of the cover shown in FIG. 10.

FIG. 12 is a front side view of the cover shown in FIG. 11

FIG. 13 is a front side view of the cover shown in FIG. 12.

FIG. 14 is a front side view of the cover shown in FIG. 13.

FIG. 15 is a rear side view of the cover shown in FIG. 14.

FIG. 16 is a side sectional view taken along line 16 shown in FIG. 15.

FIG. 17 is a rear perspective view of the cover.

FIG. 18 is an exploded rear perspective view of the cover.

FIG. 19 is a front perspective view of the cover.

FIG. 20 is an exploded front perspective view of the cover.

FIG. 21 is a front side of the cover that has been printed.

FIG. 22 is a front side view of the center section before being printed.

FIG. 23 is a front side view of an embodiment of the center section including decals for application to the temporary tag.

FIG. 24 is a front side view of the license plate section before being printed.

FIG. 25 is a front side view of the license plate section after being printed and with the decals applied.

FIG. 26 is a front side view of a second embodiment of the center section that includes blanks for a temporary vehicle registration and for an insurance affidavit to be printed.

FIG. 27 is a front side view of the second embodiment of the center section that has been printed.

FIG. 28 is a front side view of a temporary tag cover that can hold a temporary tag.

FIG. 29 is a front side view of a center section of the embodiment shown in FIG. 28.

FIG. 30 is a front side view of a center section of the embodiment shown in FIG. 28 after the license plate section has been folded over the center section.

### DETAILED DESCRIPTION OF THE INVENTION

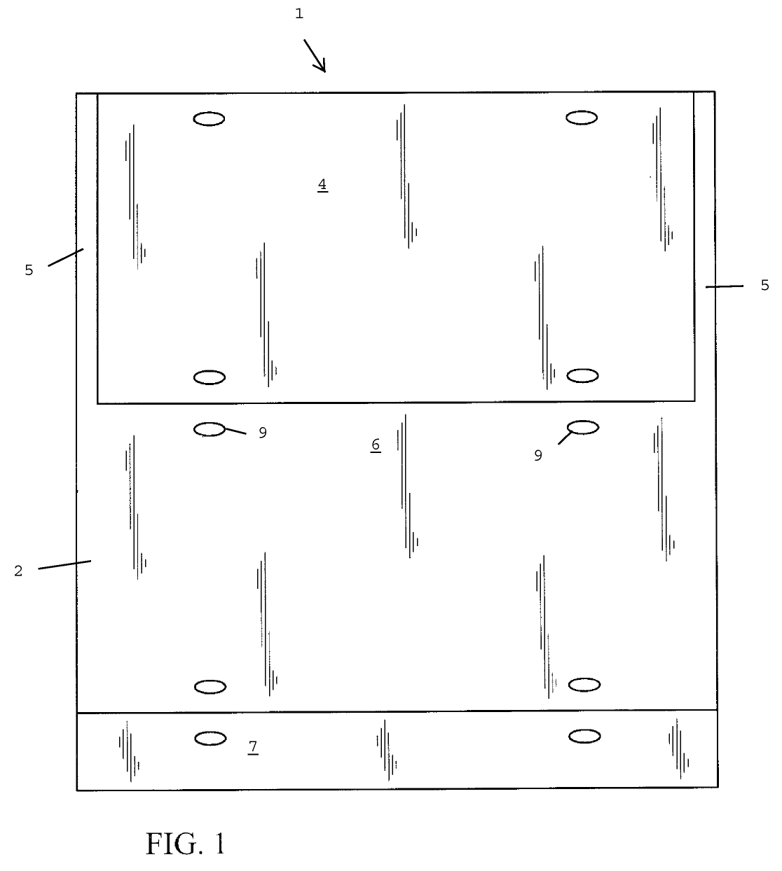

Referring now to the figures of the drawing in detail and first, particularly, to FIG. 1 thereof, there is seen a front side view of the Cover showing the segmented paper backing 2; vertical shading is used to indicate the opaque, paper layer.

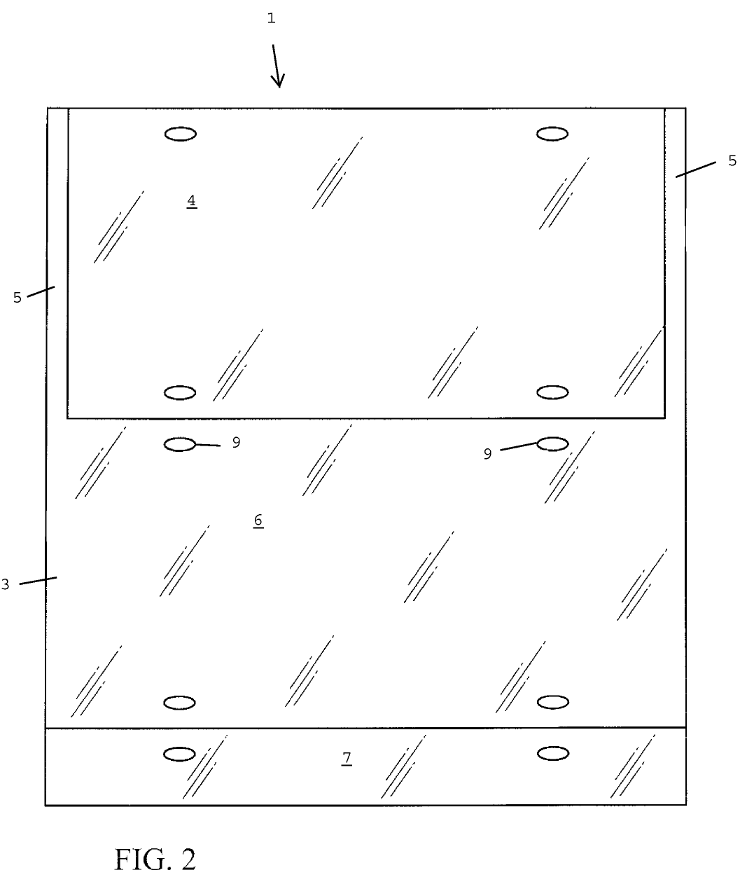

FIG. 2 is a rear side view of the cover 1 showing the transparent layer 3, diagonal shading is used to indicate the transparent layer 3. The transparent layer 3 is not segmented. The segmented paper backing 2 is visible through the transparent layer 3.

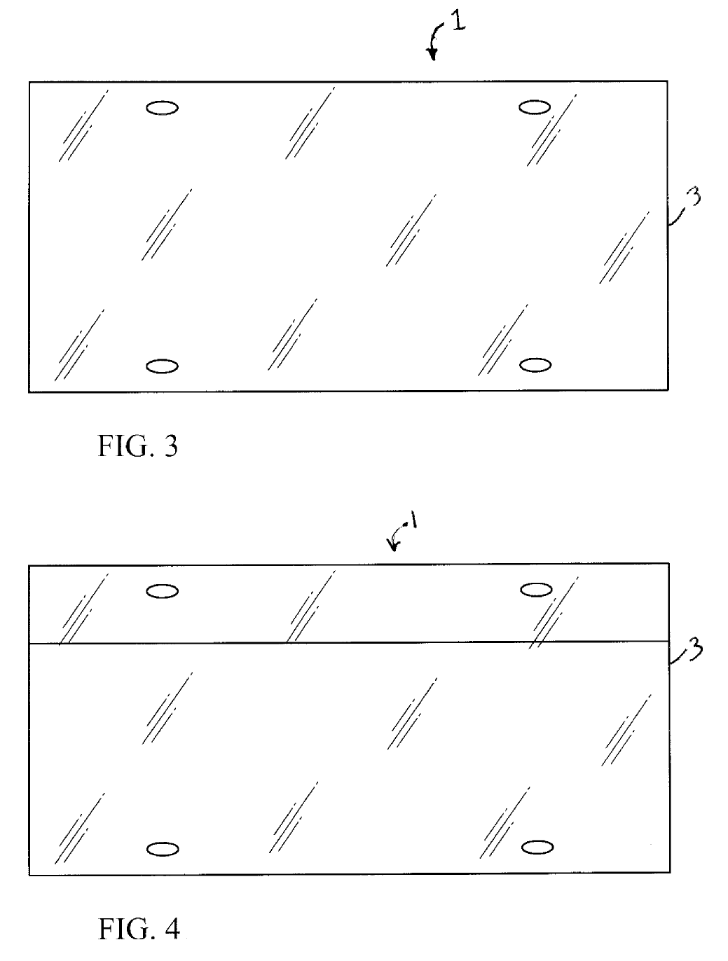

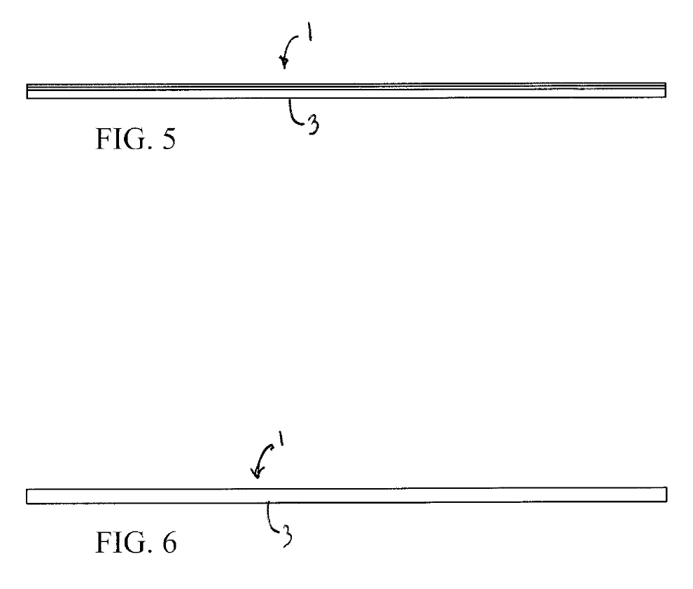

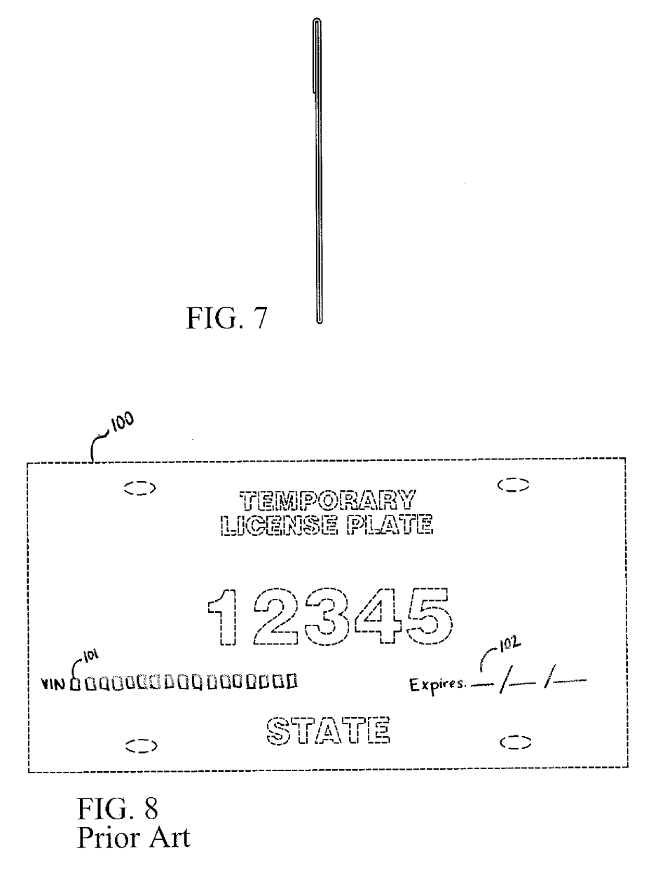

FIGS. 3-7 is a front side view of the cover 1 after the paper backing 2 has been removed and the adhesive layer 3 has been folded over itself.

FIG. 8 is a front side view of a temporary license plate 100 according to the prior art. The temporary license plate 100 has seventeen VIN numeral blanks 101 in which a Vehicle Identification Number (VIN) can be entered. An expiration date blank 102 is included in which an expiration date for the temporary license plate 100 is written.

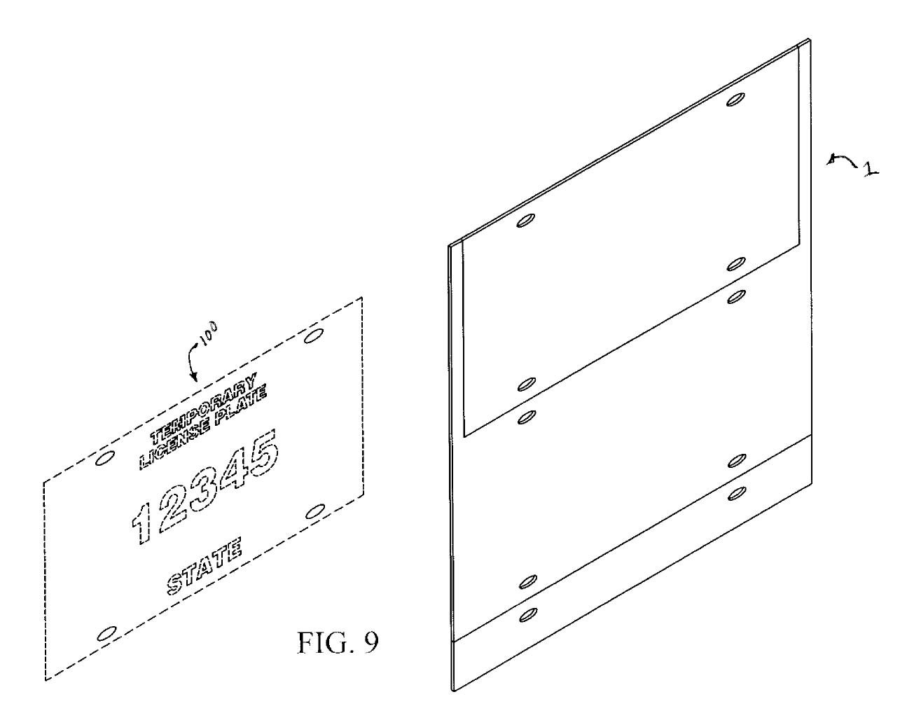

FIG. 9 is a perspective view showing the cover 1 in relation to the temporary license plate 100.

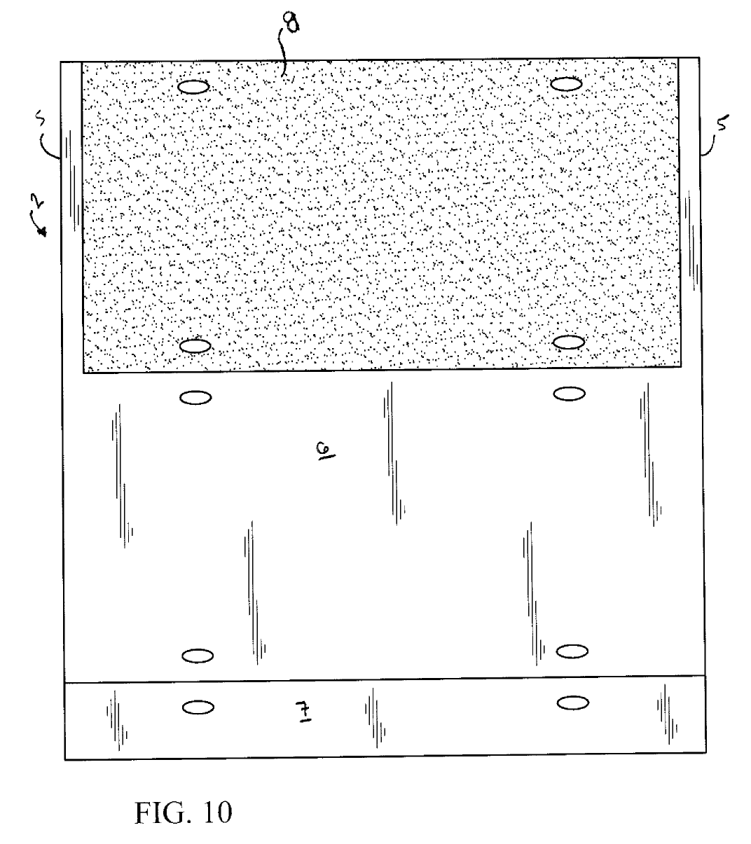

FIG. 10 is a front side view of the cover 1. A rectangular license-plate section 4 of the backing 2 has been removed to expose the pressure-sensitive adhesive 8. The pressure-sensitive adhesive is indicated by dotted shading.

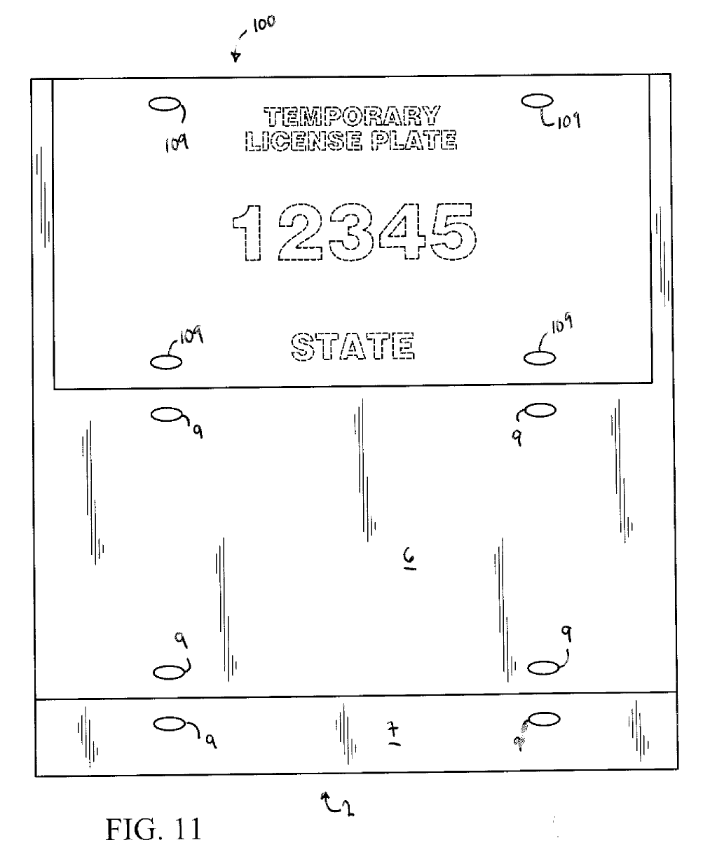

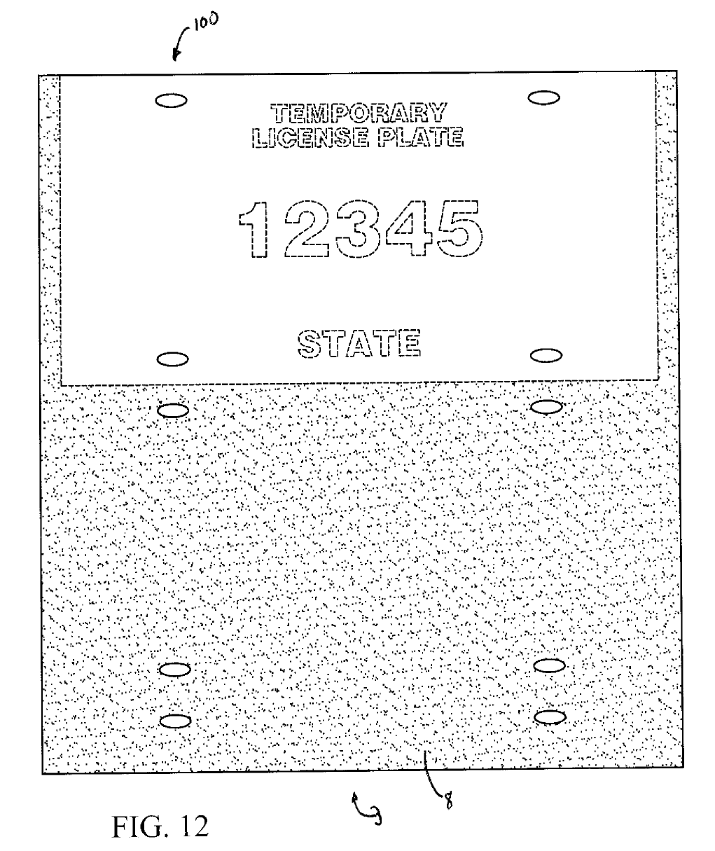

FIG. 11 is a front side view of the cover shown in FIG. 10 with the temporary license plate 100 placed on the adhesive so that the holes of the temporary license plate 109 are aligned with the holes 9 in the exposed portion of the transparent layer 3.

FIG. 12 is a front side view of the cover shown in FIG. 11 with the remaining portions (i.e. center section 6 and bottom margin 7) of the backing 2 removed to expose the adhesive 8 on the transparent layer.

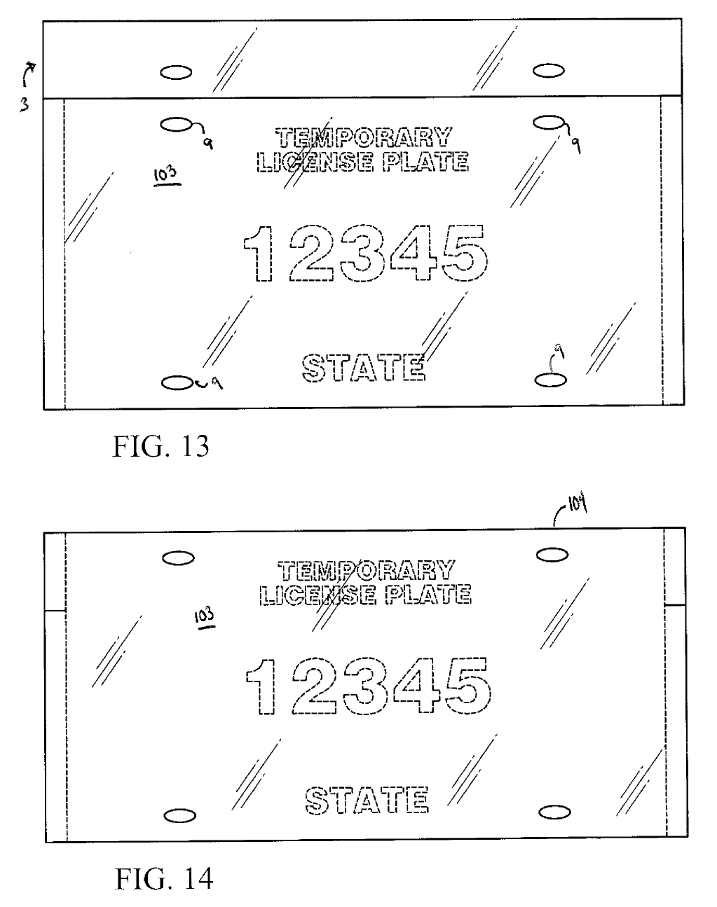

FIG. 13 is a front side view of the cover shown in FIG. 12 wherein the transparent layer 3 has been folded over the front 101 of the temporary license plate so as to align the holes 9 in the transparent layer 3 with the holes 109 in the temporary license plate 100.

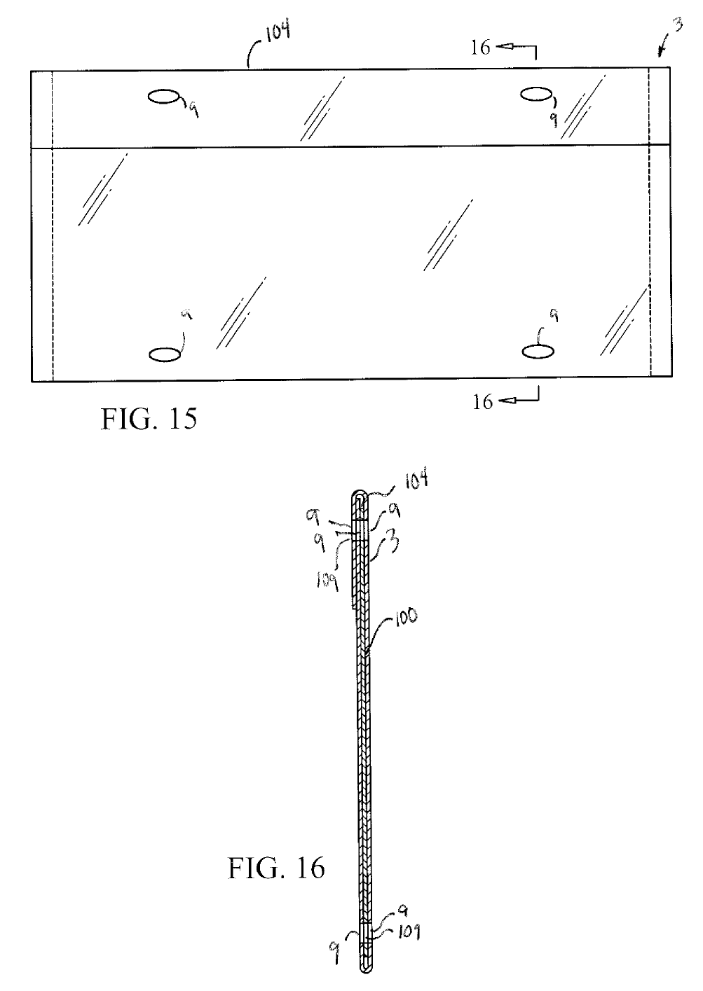

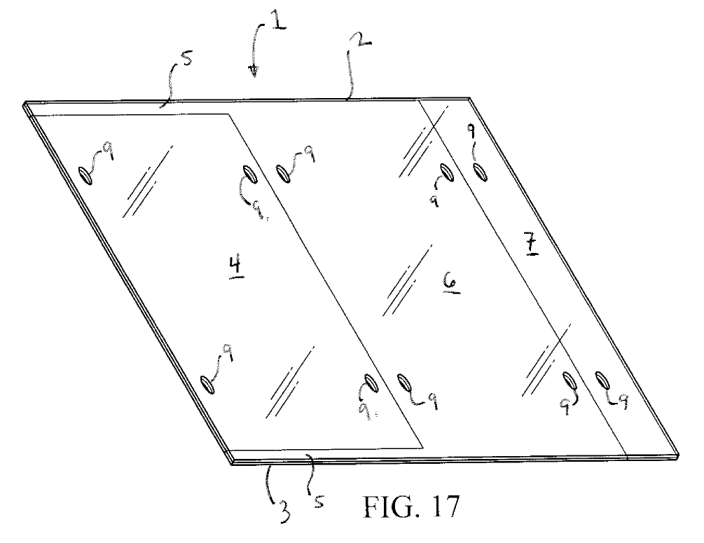

FIGS. 14-16 are views of the cover 1 shown in FIG. 13 wherein the transparent layer 3 has been folded over the top edge 104 of the temporary license plate 100 so as to align the holes 9 in the transparent layer 3 with the holes 109 in the temporary license plate 100.

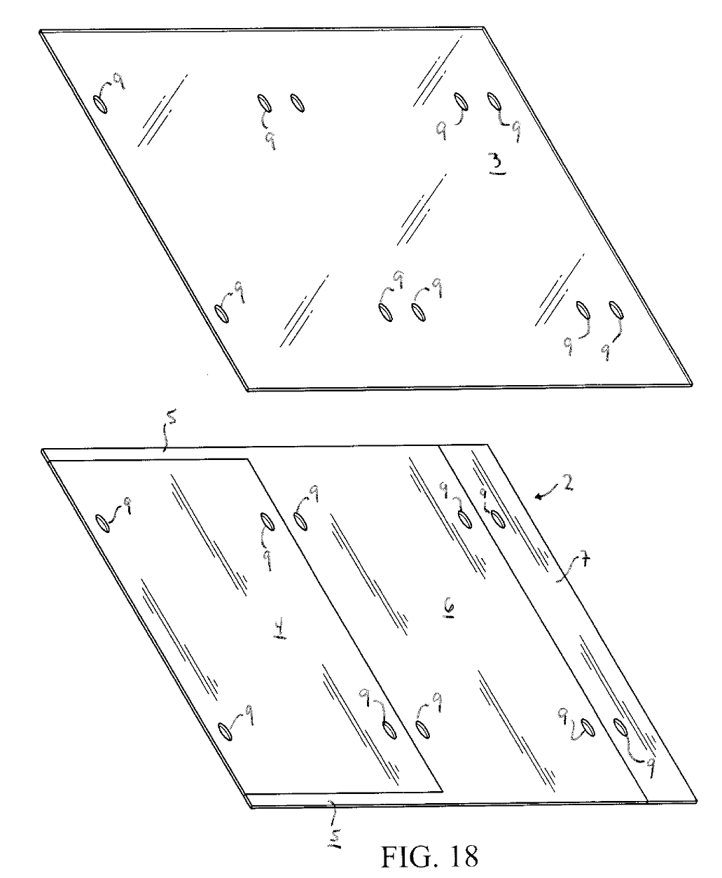

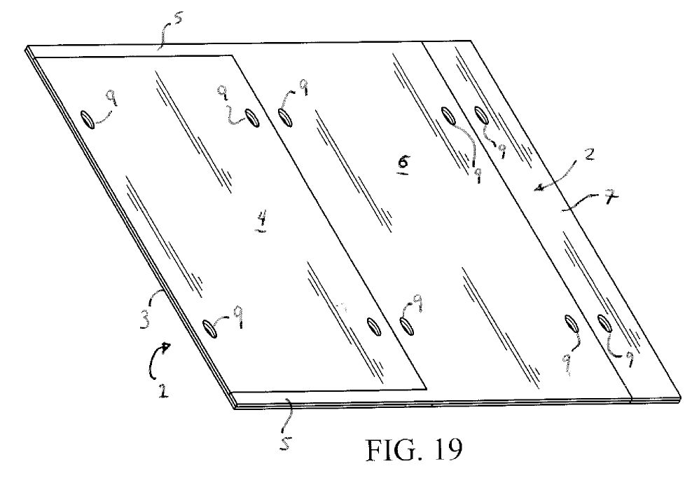

FIG. 18 is an exploded rear perspective view of the cover 1 showing the transparent layer 3 separated from the paper backing 2.

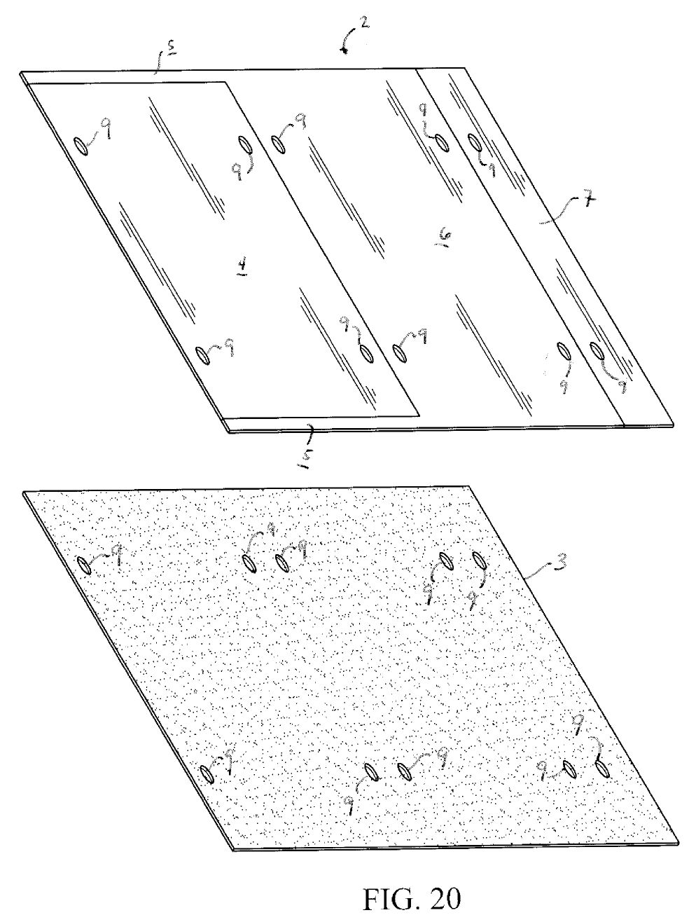

FIG. 20 is an exploded front perspective view of the cover showing the transparent layer with adhesive separated from the paper layer.

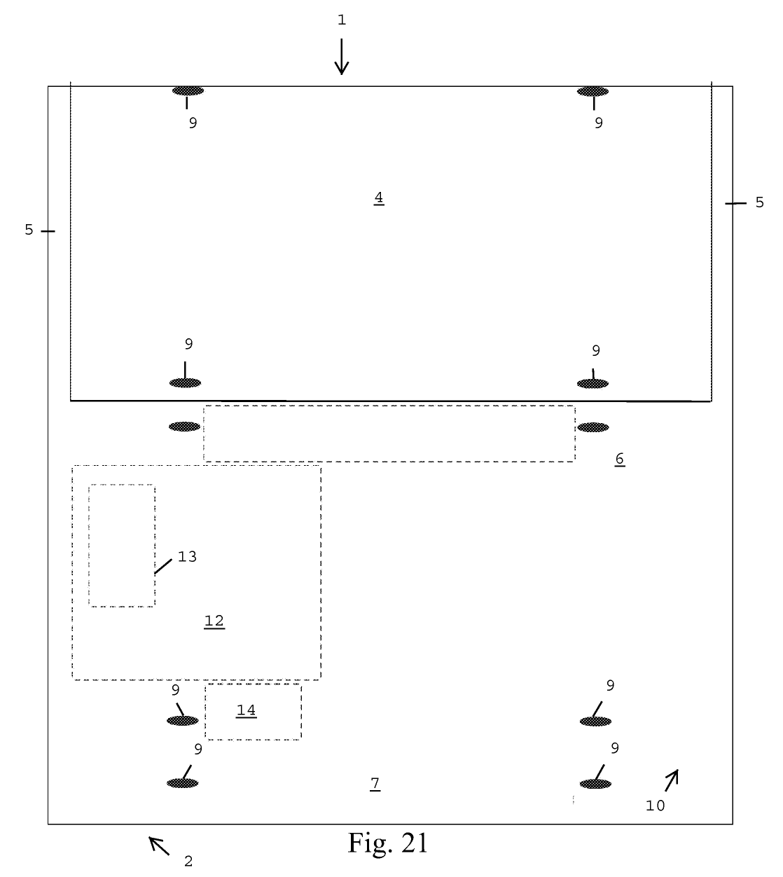

FIG. 21 shows how the backing 2 can be preprinted to be a form that is printed for use by a tag issuer. Numbered stepwise directions 10 are included on the center section 6.

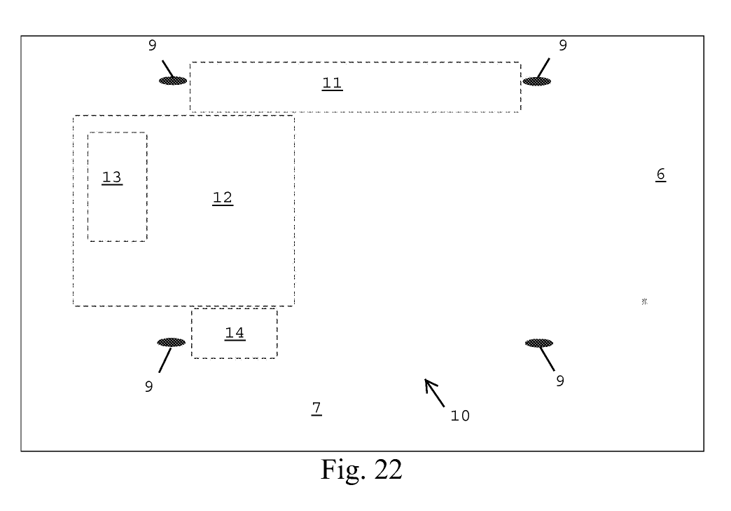

FIG. 22 shows the center section 6. A peel off and adhere state decal 11 is included to be attached to the printed tag. A punch-out temporary vehicle registration 12 is included. An expiration date decal 13, which is to be printed is attached and is to be removed after the temporary license plate is printed. A registration year decal 14, which is to be printed, is attached and is to be removed after the temporary license plate is printed.

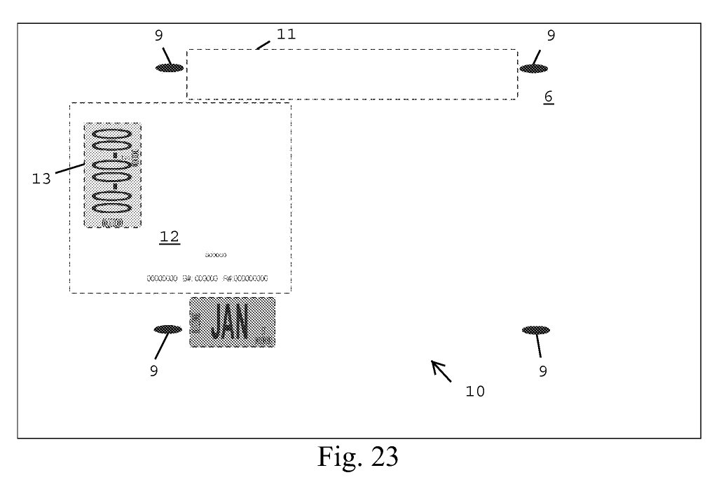

FIG. 23 shows the center section 6 after it has been printed. The sample state 11 is printed (e.g. Florida, California, etc.) with the issuing state's name. The temporary vehicle registration 12 is printed with information also entered in the DMV's database. The expiration date decal 13 is printed with the expiration date. The issuance year decal 14 is printed with the issuance year. The decals 11, 13, and 14 all include the tag number. An office can detect a fraudulent temporary tag when any of the decals do not match the temporary tag number.

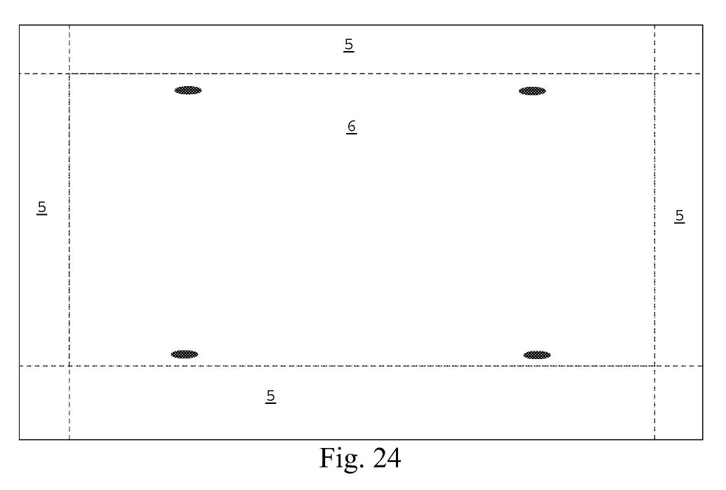

FIG. 24 shows the rectangular license plate section 4. In the embodiment shown, removable top, bottom, right, and left guide rails 5 are included. The guide rails 5 are formed by prescoring the backing 2. The guide rails 5 are removed after printing the temporary license plate. Directions 10 for printing of the temporary license plate 100 are included.

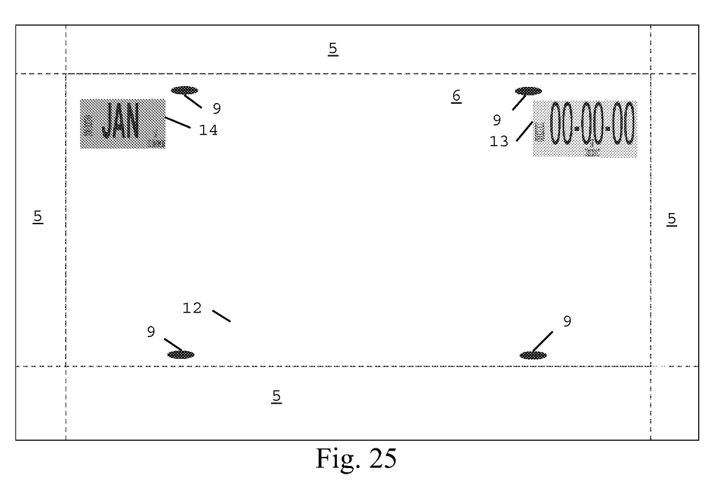

FIG. 25 shows the temporary license plate 100 after being printed. An issuing state decal 11, an expiration date decal 13, and an expiration month decal 14 have been attached after printing. The tag number 15 is printed on the temporary license plate 100 and the decals 11, 13, and 14.

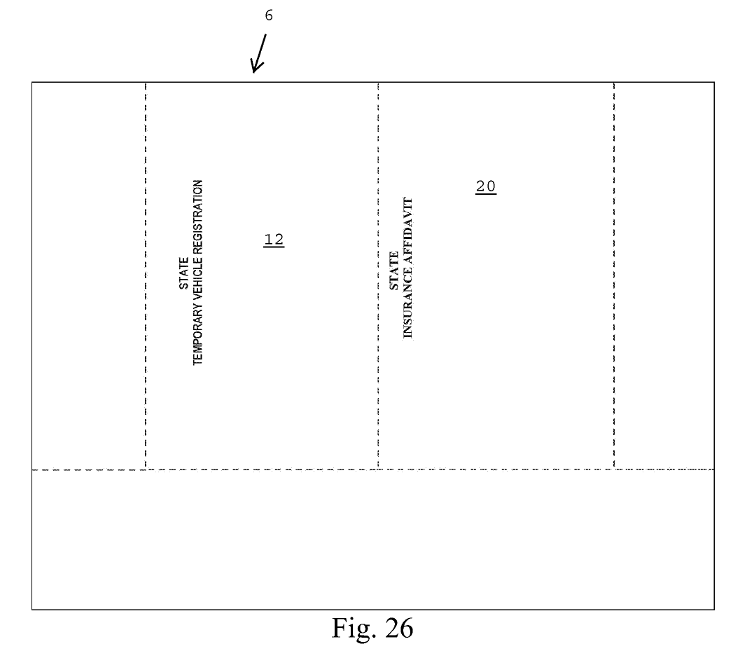

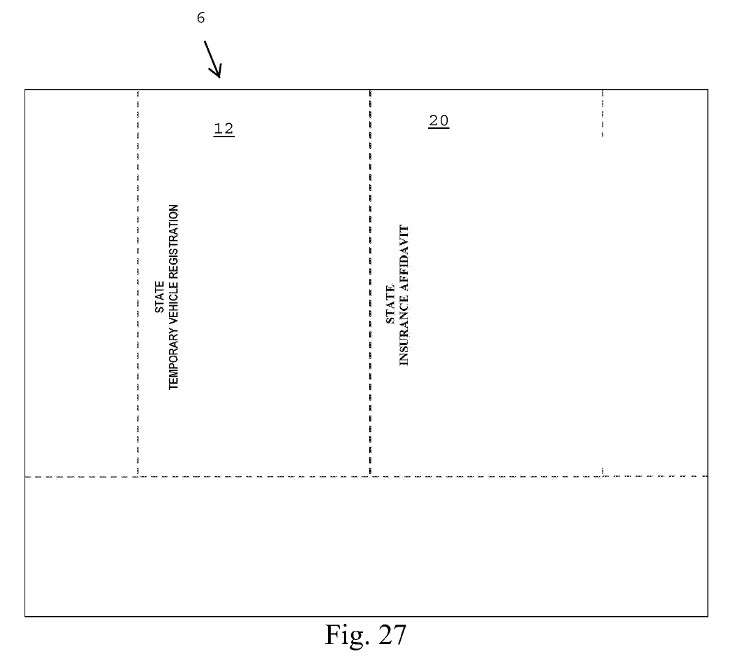

FIG. 26 is a second embodiment of a center section 6. The center section 6 includes a temporary vehicle registration 12 that is to be printed. An insurance affidavit 16 is included for the vehicle owner to verify their coverage. The tag issuer retains the insurance affidavit 16. FIG. 27 shows the second embodiment of the center section 6 after it has been printed.

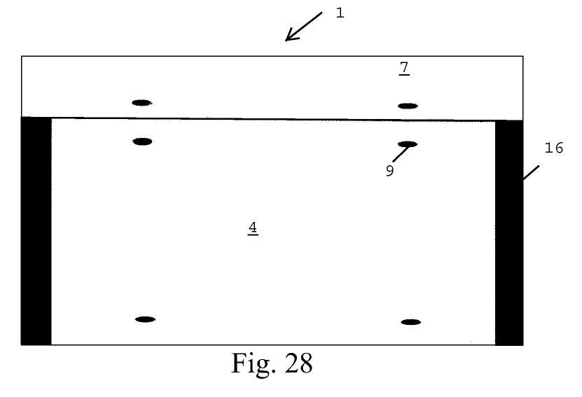

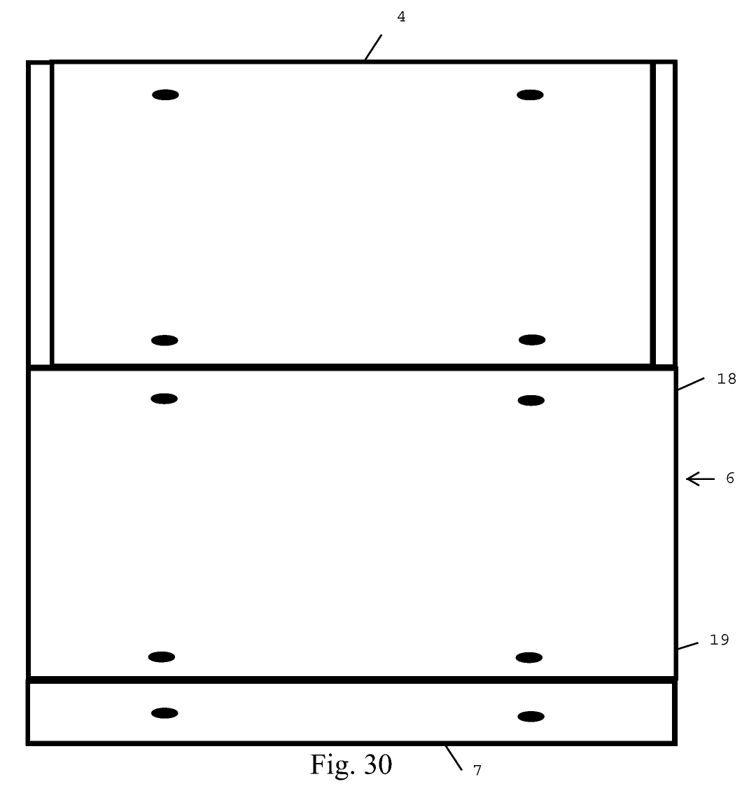

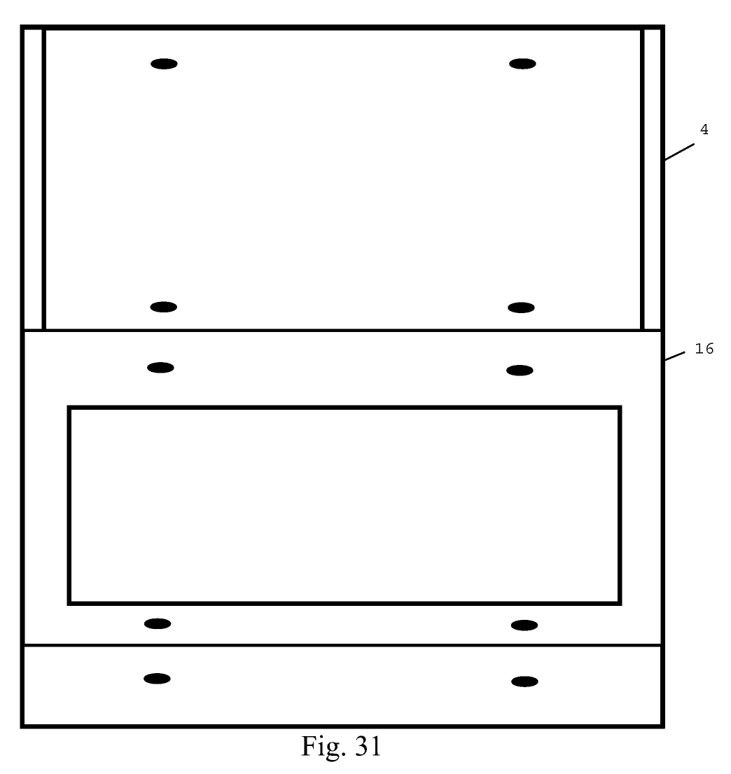

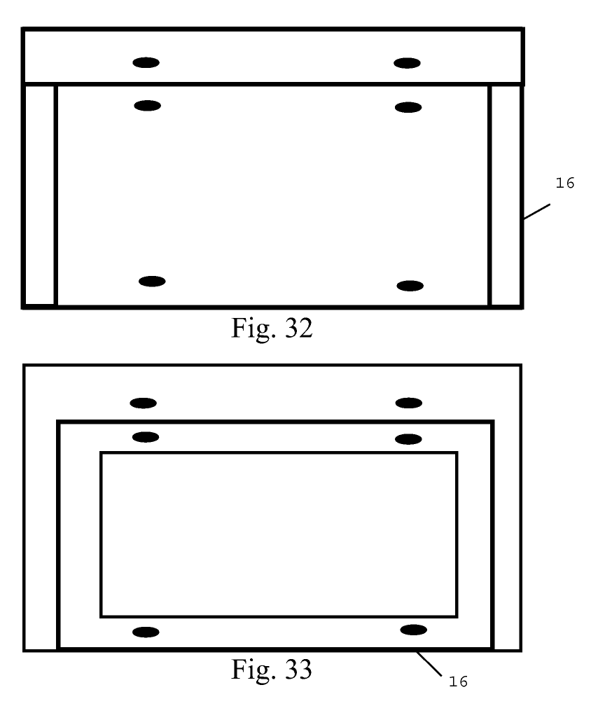

FIGS. 28, 30, and 32 show an embodiment of the temporary tag cover that allows advertising to be added in a top and bottom edge. FIG. 30 shows the cover 1. In FIG. 30, the rectangular license plate section 4 is shown preprinted. In an embodiment that is not shown, the rectangular license plate section is blank; it is then removed from the transparent layer and printed. The printed rectangular license plate is replaced and adhered on the transparent backing with the printing facing away from the transparent layer. Next, a top bar 18 and a bottom bar 19 are peeled off, flipped over and re-adhered onto the transparent backing. The top bar 18 and the bottom bar include advertising for example for a car dealership or the tag issuer. Next the inside section 17 is removed. Next, the guiderails 5 are removed. The rectangular license plate section 4 is folded over the center section so that the printed face of the rectangular license plate section 4 becomes adhered to the transparent layer 3 where the inside section 17 was removed. The bottom margin 7 is removed and folded over to complete sealing the temporary license plate in the cover. When attached to the car, the overlying top bar 18 and bottom bar 19 are still visible to show advertising. Because the printed face is adhered to the transparent layer 3, the cover 1 cannot be opened without destroying the printed face of the rectangular license plate section.

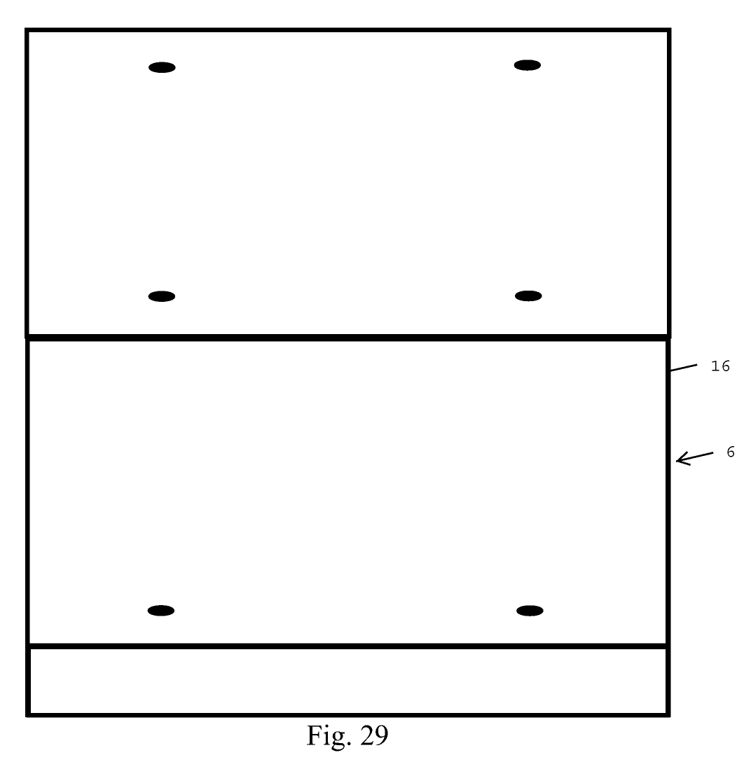

FIGS. 29, 31, and 33 show an embodiment with a frame that contains advertising. In a first step the rectangular license plate section 4 is peeled from the backing 2. The rectangular license plate section 4 is placed in a printer and the tag is printed. The rectangular license plate is then replaced on the backing 2 with the printed side up. The center section has a frame 16. The frame 16 may contain advertisements such as a dealership name. The frame 16 is removed and then replaced on the adhesive with the printed side facing the transparent layer 3. An inside section 17 is removed from the frame. The guiderailes 5 are next removed. Next, the rectangular license plate is folded over the frame. The tag information is readable through the now-exposed inside section 17. By adhering the printed side to the adhesive transparent layer 3 that is exposed in the frame 16, the cover is tamper proof.

I claim:

1. A temporary license plate, comprising:
a printable sheet; and
a transparent layer peelably adhered to the printable sheet with pressure-activated adhesive;
said printable sheet being precut into sections, the first section being a rectangular license plate section, a guide rail disposed beside each side of the license plate, a top edge of the license plate section forming the top edge of the printable sheet, a center section at least as large as the license plate section formed below the license plate section on the printable sheet, a bottom margin being included on the printed sheet that forms the bottom edge of the temporary tag.
